(19) United States
(12) Patent Application Publication
(10) Pub. No.: US 2020/0346760 A1
(43) Pub. Date: Nov. 5, 2020

(54) METHOD OF ENVIRONMENTAL CONTROL

(71) Applicant: Hamilton Sundstrand Corporation, Charlotte, NC (US)

(72) Inventors: Xiaohong Liao, Andover, CT (US); Zidu Ma, Ellington, CT (US); Gregory L. DeFrancesco, Simsbury, CT (US); Christina W. Millot, Wilbraham, MA (US)

(21) Appl. No.: 16/400,531

(22) Filed: May 1, 2019

(51) Int. Cl. B64D 13/06; B60H 3/02

(52) U.S. Cl. CPC B64D 13/06; B64D 2013/0633; B64D 2013/0662; B60H 3/024

(57) ABSTRACT

Disclosed is a method of environmental control, comprising: passing a first air stream and a second air stream through a valve; wherein the valve directs the first air stream through a first adsorption bed and directs the second air stream through a second adsorption bed; wherein the first adsorption bed produces a dehumidified air stream, and wherein the second adsorption bed is purged of moisture by the second air stream, thus producing a purge stream; and using the valve to redirect the first air stream and the second air stream when the first adsorption bed reaches a moisture saturation point or a timed interval, wherein the first air stream passes through the second adsorption bed and the second air stream passes through the first adsorption bed.

### BACKGROUND

Exemplary embodiments pertain to the art of environmental control, more particularly, to air dehumidification aboard an aircraft.

Bleed air, from a gas turbine engine of an aircraft, is compressed air taken from the compressor stage of the engine and located upstream of the fuel-burning sections. Automatic air supply and cabin pressure controller valves produce bleed air from high or low stage engine compressor sections. In order for the bleed air to be repurposed (e.g., for use in the cockpit or passenger cabin), additional processing of the air is often performed, for example dehumidification via an environmental control system.

Environmental control systems often rely on multi-step processes comprising high pressure condensers which condense water from the bleed air and allow its removal. This means that the air must be cooled down significantly prior to water removal and then reheated afterward, thus utilizing significant amounts of energy. Colder air temperatures at a turbine inlet also reduce the power output of the turbine.

Therefore, there is a need to develop a method of environmental control which reduces the number of steps needed for dehumidification of bleed air, reduces energy requirements, reduces total bleed air consumption, allows bypass of a heat exchanger and/or a condenser unit, increases turbine power output, and avoids phase changes.

### BRIEF DESCRIPTION

Disclosed is a method of environmental control, comprising: passing a first air stream and a second air stream through a valve; wherein the valve directs the first air stream through a first adsorption bed and directs the second air stream through a second adsorption bed; wherein the first adsorption bed produces a dehumidified air stream, and wherein the second adsorption bed is purged of moisture by the second air stream, thus producing a purge stream; and using the valve to redirect the first air stream and the second air stream when the first adsorption bed reaches a moisture saturation point or a timed interval, wherein the first air stream passes through the second adsorption bed and the second air stream passes through the first adsorption bed.

### BRIEF DESCRIPTION OF THE DRAWINGS

The following descriptions should not be considered limiting in any way. With reference to the accompanying drawings, like elements are numbered alike:

FIG. 1 is a system for an environmental control method according to an exemplary embodiment;

FIG. 2 is a graph of total moisture ratio (grains moisture per pound of air, gr/lb) versus temperature (° F.) for a method of environmental control for comparative purposes; and

FIG. 3 is a graph of total moisture ratio (gr/lb) versus temperature (° F.) for a method of environmental control according to an exemplary embodiment.

### DETAILED DESCRIPTION

A detailed description of one or more embodiments of the disclosed apparatus and method are presented herein by way of exemplification and not limitation with reference to the Figures.

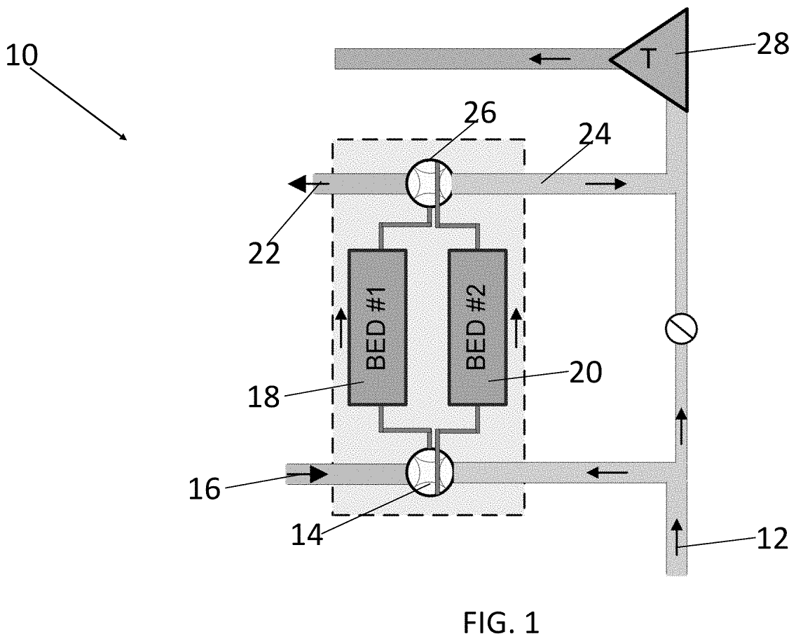

Referring to FIG. 1, a system 10 according to one embodiment is illustrated. The system 10 can be utilized in a method of dehumidifying bleed air. The system receives a first air stream 12 and a second air stream 16 through a valve 14. The first air stream 12 can comprise water moisture. For example, the first air stream 12 can have a total moisture ratio of about 80 grains moisture per pound of air to about 120 grains moisture per pound of air, for example, the first air stream 14 can have a total moisture ratio of about 90 grains moisture per pound of air to about 110 grains moisture per pound of air. For example, the first air stream 14 can comprise compressed air, for example, bleed air from an aircraft engine. The second air stream 16 can, for example, comprise recycled dehumidified air, ambient air, or a combination thereof.

The system 10 includes a first adsorption bed 18 and a second adsorption bed 20 In one configuration, the valve 14 directs the first air stream 12 through the first adsorption bed 18 and directs the second air stream 16 through the second adsorption bed 20. For example, the directing of the first air stream 12 and the second air stream 16 via the valve 14 can occur simultaneously. The first air stream 12 and the second air stream 16 can also remain separate from each other (i.e., not mixed) as they pass through the valve 14. For example, the valve 14 can be a 4-way valve.

The first adsorption bed 18, the second adsorption bed 20, or a combination thereof, can include a desiccant material. For example, the desiccant material can attract and hold water molecules from the surrounding environment via adsorption. For example, the desiccant material can comprise activated alumina, aerogel, benzophenone, bentonite clay, calcium chloride, calcium oxide, calcium sulfate, cobalt (II) chloride, copper (II) sulfate, lithium chloride, lithium bromide, magnesium sulfate, magnesium perchlorate, molecular sieve, phosphorus pentoxide, potassium carbonate, potassium hydroxide, silica gel, sodium, sodium chlorate, sodium chloride, sodium hydroxide, sodium sulfate, sucrose, sulfuric acid, a zeolite (e.g., analcime, chabazite, clinoptilite, mordenite, natrolite, heulandite, phillipsite, stilbite), or a combination thereof.

The output of the first adsorption bed 18 can be a dehumidified air stream 24. For example, the first air stream 12 may pass the first adsorption bed 18 and contact the desiccant material. This can facilitate physical adhesion of water molecules from the first air stream 12 to a surface of the desiccant material in the first adsorption bed 18, thus removing water molecules from the first air stream 12 and producing a dehumidified air stream 24. For example, the first adsorption bed 18 may utilize pressure swing adsorption, wherein increased pressure of an air stream can increase the adsorption rates of water molecules from the air stream. This adsorption method can be physical in nature. In other words, the first air stream 12 does not undergo a chemical change and/or a phase change. The method disclosed herein can also allow bypass of a condenser unit prior to removal of moisture from the first air stream 12.

A temperature of the dehumidified air stream 24 can be greater than or equal to a temperature of the first air stream 12. For example, a temperature of the first air stream 12 can be about 150° F. to about 200° F., for example, about 160° F. to about 180° F. A temperature of the dehumidified air stream 24 can be about 200° F. to about 250° F., for example, about 200° F. to about 220° F. Due to the maintenance or increase in temperature of the first air stream 12, the method disclosed herein can allow bypass of a heat exchange unit.

A total moisture ratio in grains of moisture per pound of air of the dehumidified air stream 24 can be reduced by greater than or equal to 50%, for example, greater than or equal to 60%, as compared to a total moisture ratio in grains of moisture per of pound air of the first air stream 12. For example, the dehumidified air stream 24 can have a total moisture ratio of about 20 grains of moisture per pound of air to about 60 grains of moisture per pound of air, for example, about 30 grains of moisture per pound of air to about 50 grains of moisture per pound of air.

The second adsorption bed 20 can be purged of moisture by the second air stream 16, thus regenerating the second adsorption bed 20 and producing a purge stream 22. For example, due to the initial physical adsorption of water molecules from the air by the second adsorption bed 20, the resulting surface hydration in the bed can then be subsequently eliminated via simple air drying (i.e., passage of air through the bed) at conditions of temperature and pressure that allow full vaporization of water. In other words, no chemical change and/or phase change is needed in the second adsorption bed 20.

In another configuration, the valve 14 directs the first air stream 12 to pass through the second adsorption bed 20 (i.e., rather than the first adsorption bed 18) and the second air stream 16 to pass through the first adsorption bed 18. This redirection of the air streams can occur via adjustment (e.g., rotation) of the valve 14, for example, the 4-way valve 14. Adjustment of the valve 14 can occur, for example, via an automated controller.

This redirection can accomplish a role reversal of the two streams 12, 16 and beds 18, 20. For example, initially the first adsorption bed 18 dehumidifies the first air stream 12 while the second air stream 16 purges the second adsorption bed 20 of adsorbed water molecules. Then following adjustment (e.g., rotation) of the valve 14 and redirection of the streams 12 and 16, the second adsorption bed 20 dehumidifies the first air stream 12 while the second air stream 16 purges the first adsorption bed 18 of adsorbed water molecules. The method can then be repeated as many times as desired. Accordingly, the method can run continuously without stoppage for bed regeneration.

This redirection and role-reversal can occur when the first adsorption bed 18 and/or the second adsorption bed 20 reaches a moisture saturation point and/or a timed interval. For example, the moisture saturation point can be greater than or equal to 50%, for example, greater than or equal to 75%, for example, greater than or equal to 90%, moisture saturation of the first adsorption bed 18 and/or the second adsorption bed 20. The timed interval can be about 1 minute to about 60 minutes, for example, about 5 minutes to about 30 minutes, for example, about 10 minutes to about 15 minutes.

In one embodiment, the first air stream 12 is compressed prior to passing through the valve 14. In one embodiment, the system 10 includes a second valve 26. This second valve is connected to the output of the first and second adsorption beds 18, 20. The second valve 26 can direct the dehumidified air stream 24 and the purge stream 22 to further use and/or processing. For example, the second valve 26 can cause the dehumidified air stream 24 to pass through a turbine 28.

The system 10 disclosed herein be used in a method that takes place aboard an aircraft. For example, a source of the first air stream 12 can be bleed air from an aircraft engine. In one embodiment, the dehumidified air stream 24 can be passed to a cockpit of an aircraft, an avionics system of an aircraft, a passenger cabin of an aircraft, or a combination thereof.

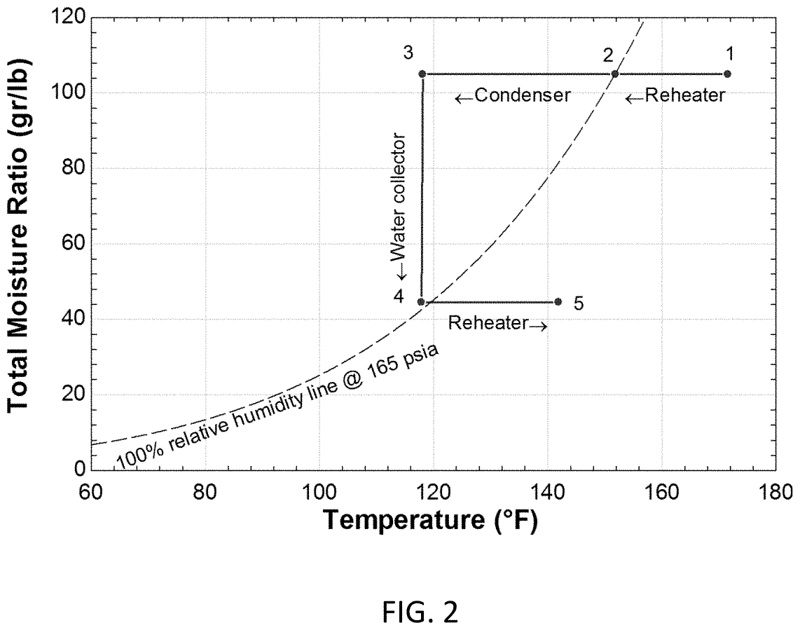

Referring now to FIG. 2, a graph is shown of total moisture ratio (grains moisture per pound of air, gr/lb) versus temperature (° F.) for a method of environmental control for comparative purposes. As can be seen, environmental control systems often rely on multi-step processes (1-5) comprising high pressure condensers which condense the bleed air and allow water removal. This means that the air must be cooled down significantly prior to water removal and then reheated afterward, thus utilizing significant amounts of energy. This is represented by lateral movement across the x-axis. Colder air temperatures at a turbine inlet also reduce the power output of the turbine.

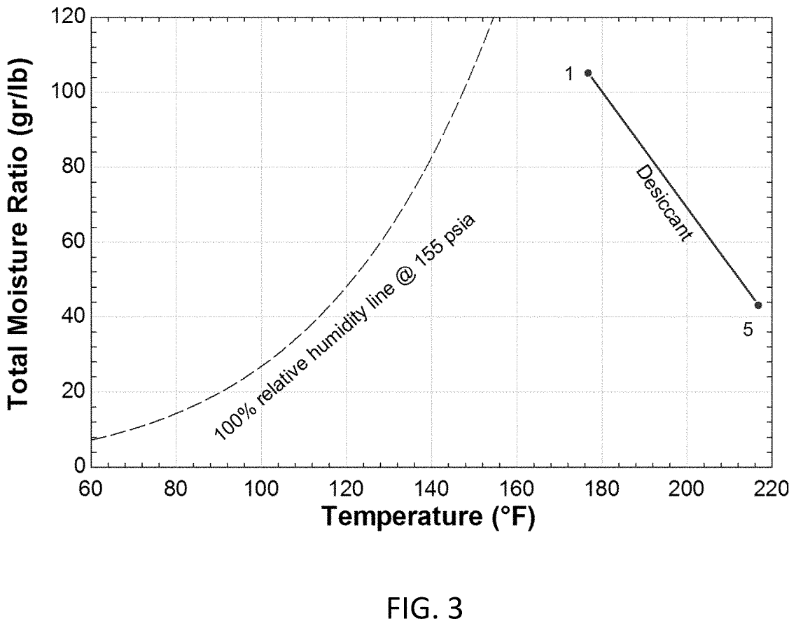

In contrast, referring now to FIG. 3, a graph is shown of total moisture ratio (gr/lb) versus temperature (° F.) for a method of environmental control according to an exemplary embodiment. As can be seen, lateral movement across the x-axis is significantly decreased. Accordingly, the present disclosure provides a method of environmental control which reduces the number of steps needed for dehumidification of bleed air, reduces energy requirements, reduces total bleed air consumption, allows bypass of a heat exchanger and/or a condenser unit, increases turbine power output, and avoids phase changes.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components (and encompasses “consist(s) of”, “consisting of”, “consist(s) essentially of” and “consisting essentially of”), but do not necessarily preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of environmental control, comprising:
passing a first air stream and a second air stream through a valve;
wherein the valve directs the first air stream through a first adsorption bed and directs the second air stream through a second adsorption bed;
wherein the first adsorption bed produces a dehumidified air stream, and wherein the second adsorption bed is purged of moisture by the second air stream, thus producing a purge stream; and
using the valve to redirect the first air stream and the second air stream when the first adsorption bed reaches a moisture saturation point or a timed interval, wherein the first air stream passes through the second adsorption bed and the second air stream passes through the first adsorption bed.

2. The method of environmental control of claim 1, wherein the first adsorption bed, the second adsorption bed, or a combination thereof, comprises a desiccant material.

3. The method of environmental control of claim 2, wherein the desiccant material comprises activated alumina, aerogel, benzophenone, bentonite clay, calcium chloride, calcium oxide, calcium sulfate, cobalt (II) chloride, copper (II) sulfate, lithium chloride, lithium bromide, magnesium sulfate, magnesium perchlorate, molecular sieve, phosphorus pentoxide, potassium carbonate, potassium hydroxide, silica gel, sodium, sodium chlorate, sodium chloride, sodium hydroxide, sodium sulfate, sucrose, sulfuric acid, analcime, chabazite, clinoptilite, mordenite, natrolite, heulandite, phillipsite, stilbite, or a combination thereof.

4. The method of environmental control of claim 1, wherein a temperature of the dehumidified air stream is greater than or equal to a temperature of the first air stream.

5. The method of environmental control of claim 1, wherein a temperature of the first air stream is about 150° F. to about 200° F.

6. The method of environmental control of claim 1, wherein a temperature of the dehumidified air stream is about 200° F. to about 250° F.

7. The method of environmental control of claim 1, wherein a total moisture ratio in grains of moisture per pound of air of the dehumidified air stream is reduced by greater than or equal to 50% as compared to a total moisture ratio in grains of moisture per of pound air of the first air stream.

8. The method of environmental control of claim 1, wherein the first air stream has a total moisture ratio of about 80 grains of moisture per pound of air to about 120 grains of moisture per pound of air.

9. The method of environmental control of claim 1, the dehumidified air stream has a total moisture ratio of about 20 grains of moisture per pound of air to about 60 grains of moisture per pound of air.

10. The method of environmental control of claim 1, wherein the valve is a 4-way valve.

11. The method of environmental control of claim 1, further comprising compressing the first air stream prior to passing through the valve.

12. The method of environmental control of claim 1, further comprising passing the dehumidified air stream and the purge stream through a second valve.

13. The method of environmental control of claim 1, further comprising passing the dehumidified air stream through a turbine.

14. The method of environmental control of claim 1, wherein the first air stream does not undergo a phase change, a chemical change, or a combination thereof.

15. The method of environmental control of claim 1, wherein the first air stream does not pass through a heat exchanger.

16. The method of environmental control of claim 1, wherein the first air stream does not pass through a condenser.

17. The method of environmental control of claim 7, wherein a total moisture ratio in grains of moisture per pound of air of the dehumidified air stream is reduced by greater than or equal to 60% as compared to a total moisture ratio in grains of moisture per of pound air of the first air stream.

18. The method of environmental control of claim 1, wherein the method takes place aboard an aircraft.

19. The method of environmental control of claim 1, wherein a source of the first air stream is bleed air from an aircraft engine.

20. The method of environmental control of claim 1, further comprising passing the dehumidified air stream to a cockpit of an aircraft, an avionics system of an aircraft, a passenger cabin of an aircraft, or a combination thereof.
